(19) United States
(12) Patent Application Publication
(10) Pub. No.: US 2024/0187909 A1
(43) Pub. Date: Jun. 6, 2024

(54) CHANNEL STATE INFORMATION REPORTING CONFIGURATION FOR DYNAMIC USER SCENARIOS

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/552,396

(22) PCT Filed: Mar. 24, 2022
(86) PCT No.: PCT/IB2022/052681

§ 371 Date: Sep. 25, 2023

Related U.S. Application Data
(60) Provisional application No. 63/165,608, filed on Mar. 24, 2021.

(51) Int. Cl. H04W 24/10; H04B 7/06; H04L 5/00

(52) U.S. Cl. CPC H04W 24/10; H04B 7/0621; H04L 5/0048

(57) ABSTRACT

Apparatuses, methods, and systems are described for channel state information reporting configuration for dynamic user scenarios. An apparatus (1300) includes a transceiver (1325) that receives a set of one or more CSI reporting settings for configuring the UE for CSI reporting, receives at least two CSI resource settings for configuring the UE for CSI measurements, and receives an indication of an enhanced CSI configuration associated with at least one of the one or more received CSI reporting settings and the at least two received CSI resource settings. The apparatus (1300) includes a processor (1305) that generates one or more CSI reports based on at least one of a subset of the set of one or more received CSI reporting settings and a subset of the received set of two or more CSI resource settings. The transceiver (1325) transmits the one or more generated CSI reports.

### CROSS-REFERENCE TO RELATED APPLICATIONS

This application claims the benefit of U.S. Provisional Patent Application No. 63/165,608, entitled “CONCISE CSI REPORTING CONFIGURATION FOR DYNAMIC USER SCENARIOS” and filed on Mar. 24, 2021, for Ahmed Hindy, et al., which is incorporated herein by reference.

### FIELD

The subject matter disclosed herein relates generally to wireless communications and more particularly relates to channel state information reporting configuration for dynamic user scenarios.

### BACKGROUND

For third generation partnership project (“3GPP”) new radio (“NR”), channel state information (“CSI”) feedback is reported by a user equipment (“UE”) to the network where the CSI feedback can take multiple forms based on the CSI feedback report size, time, and frequency granularity. In NR Rel. 16, a high-resolution CSI feedback report (Type-II) was specified, where the frequency granularity of the CSI feedback can be indirectly parametrized. In addition, scenarios in which the UE speed is relatively high (e.g., up to 500 km/h) are also being studied in NR Rel. 17. In order to accommodate such scenarios while maintaining similar quality of service, a modified CSI framework, including measurement and reporting, are needed.

### BRIEF SUMMARY

Disclosed are solutions for channel state information reporting configuration for dynamic user scenarios.

In one embodiment, a first apparatus includes a transceiver that receives, from a network, a set of one or more channel state information (“CSI”) reporting settings for configuring the UE for CSI reporting. In one embodiment, the transceiver receives, from the network, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the transceiver receives, from the network, an indication of an enhanced CSI configuration associated with at least one of the one or more received CSI reporting settings and the at least two received CSI resource settings. In one embodiment, the first apparatus includes a processor that generates, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement. In one embodiment, the transceiver transmits, to the network, the one or more generated CSI reports.

In one embodiment, a first method receives, from a network, a set of one or more channel state information (“CSI”) reporting settings for configuring the UE for CSI reporting. In one embodiment, the first method receives, from the network, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the first method receives, from the network, an indication of an enhanced CSI configuration associated with at least one of the one or more received CSI reporting settings and the at least two received CSI resource settings. In one embodiment, the first method generates, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement. In one embodiment, the first method transmits, to the network, the one or more generated CSI reports.

In one embodiment, a second apparatus includes a transceiver that transmits, to a user equipment (“UE”), a set of one or more channel state information (“CSI”) reporting settings for configuring the UE for CSI reporting. In one embodiment, the transceiver transmits, to the UE, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the transceiver transmits, to the UE, an indication of an enhanced CSI configuration associated with at least one of the one or more received CSI reporting settings and the at least two received CSI resource settings. In one embodiment, the transceiver receives, from the UE, one or more CSI reports generated based on at least one of a subset of the set of one or more received CSI reporting settings for configuring the UE for CSI reporting and a subset of the received set of two or more CSI resource settings for configuring the UE for CSI measurement.

In one embodiment, a second method transmits, to a user equipment (“UE”), a set of one or more channel state information (“CSI”) reporting settings for configuring the UE for CSI reporting. In one embodiment, the second method transmits, to the UE, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the second method transmits, to the UE, an indication of an enhanced CSI configuration associated with at least one of the one or more received CSI reporting settings and the at least two received CSI resource settings. In one embodiment, the second method receives, from the UE, one or more CSI reports generated based on at least one of a subset of the set of one or more received CSI reporting settings for configuring the UE for CSI reporting and a subset of the received set of two or more CSI resource settings for configuring the UE for CSI measurement.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for channel state information reporting configuration for dynamic user scenarios;

FIG. 2 is a diagram illustrating one embodiment of an aperiodic trigger state defining a list of CSI report settings;

FIG. 3 is a diagram illustrating one embodiment of aperiodic trigger state definition indicating the resource set and QCL information;

FIG. 4 is a diagram illustrating one embodiment of RRC configuration for NZP-CSI-RS resource;

FIG. 5 is a diagram illustrating one embodiment of RRC configuration for CSI-IM-resource;

FIG. 6 is a diagram illustrating one embodiment of Partial CSI omission for PUSCH-Based CSI;

FIG. 7 is a diagram illustrating one example of ASN.1 code for CSI-ReportConfig Reporting Setting IE with enhanced CSI framework;

FIG. 8 is a diagram illustrating one example of ASN.1 code for triggering more CSI Part0 within CSI-ReportConfig Reporting Setting IE;

FIG. 9 is a diagram illustrating one example of ASN.1 code for triggering CSI Part0 within CodebookConfig Codebook Configuration IE;

FIG. 10 is a diagram illustrating one example of ASN.1 code for triggering two CSI resource settings for channel measurement;

FIG. 11 is a diagram illustrating one example of ASN.1 code for setting additional values for report Quantity;

FIG. 12 is a diagram illustrating one embodiment of a NR protocol stack;

FIG. 13 is a block diagram illustrating one embodiment of a user equipment apparatus that may be used for channel state information reporting configuration for dynamic user scenarios;

FIG. 14 is a block diagram illustrating one embodiment of a network equipment apparatus that may be used for channel state information reporting configuration for dynamic user scenarios; and

FIG. 15 is a flowchart diagram illustrating one embodiment of a method for channel state information reporting configuration for dynamic user scenarios.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for channel state information reporting configuration for dynamic user scenarios. For 3GPP NR, CSI feedback is reported by the UE to the network, where the CSI feedback can take multiple forms based on the CSI feedback report size, time and frequency granularity. In NR Rel. 16, high-resolution CSI feedback report (Type-II) was specified, where the frequency granularity of the CSI feedback can be indirectly parametrized. In addition, scenarios in which the UE speed is relatively high (e.g., up to 500 km/h) are also being studied in NR Rel. 17. In order to accommodate such scenarios while maintaining similar quality of service, a modified CSI framework, including measurement and reporting, are needed.

In this disclosure, solutions are proposed that enable CSI measurement and reporting that is suited for high-Doppler scenarios, where the relative UE speed is relatively high. Due to the high UE speed, the network configuration, indication of either the CSI Reporting Setting, the CSI Resource Setting, or both, may be outdated. On the other hand, UE-based CSI Reporting and Resource Setting may both improve the performance and resolve the latency issue; however, it can be either inconvenient or unapplicable from a network perspective. In light of that, striking a good balance between latency, performance and complexity is addressed.

In this disclosure, methods and systems were proposed to address CSI framework enhancements. Different embodiments of CSI Reporting Configuration and CSI Resource Configuration are presented. More specifically, details of the CSI resource setting for aperiodic, semi-persistent, and periodic time-domain behaviors. Additionally, CSI-RS partitioning and enhancements on CSI Reporting are also discussed. Several embodiments and examples are described to explain the proposals and clarify how they can be adopted in practical scenarios.

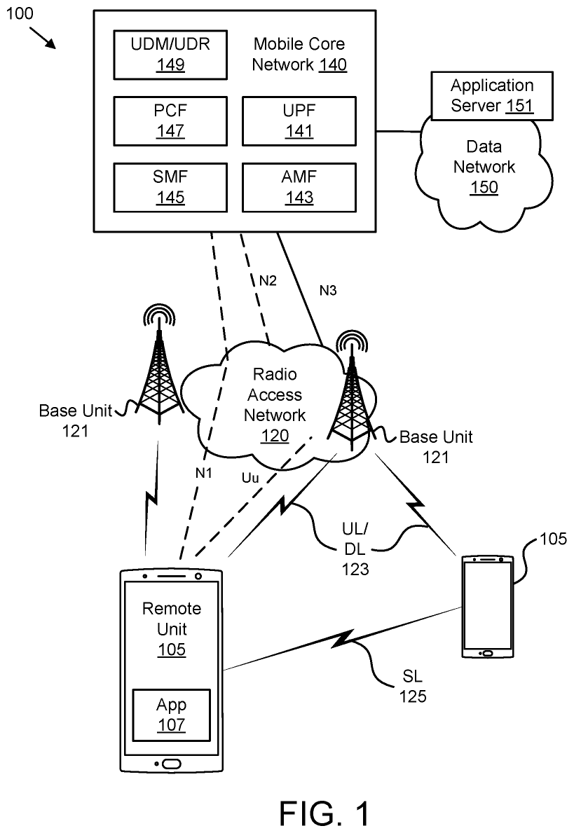

FIG. 1 depicts a wireless communication system 100 supporting channel state information reporting configuration for dynamic user scenarios, according to embodiments of the disclosure. In one embodiment, the wireless communication system 100 includes at least one remote unit 105, a radio access network (“RAN”) 120 (e.g., a NG-RAN), and a mobile core network 140. The RAN 120 and the mobile core network 140 form a mobile communication network. The RAN 120 may be composed of a base unit 110 with which the remote unit 105 communicates using wireless communication links 115. Even though a specific number of remote units 105, base units 110, wireless communication links 115, RANs 120, and mobile core networks 140 are depicted in FIG. 1, one of skill in the art will recognize that any number of remote units 105, base units 110, wireless communication links 115, RANs 120, and mobile core networks 140 may be included in the wireless communication system 100.

In one implementation, the RAN 120 is compliant with the 5G system specified in the 3GPP specifications. In another implementation, the RAN 120 is compliant with the LTE system specified in the 3GPP specifications. More generally, however, the wireless communication system 100 may implement some other open or proprietary communication network, for example WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 110 in the RAN 120 via uplink (“UL”) and downlink (“DL”) communication signals. Furthermore, the UL and DL communication signals may be carried over the wireless communication links 115. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone/VoIP application) in a remote unit 105 may trigger the remote unit 105 to establish a PDU session (or other data connection) with the mobile core network 140 via the RAN 120. The mobile core network 140 then relays traffic between the remote unit 105 and the application server 151 in the packet data network 150 using the PDU session. Note that the remote unit 105 may establish one or more PDU sessions (or other data connections) with the mobile core network 140. As such, the remote unit 105 may concurrently have at least one PDU session for communicating with the packet data network 150 and at least one PDU session for communicating with another data network (not shown).

The base units 110 may be distributed over a geographic region. In certain embodiments, a base unit 110 may also be referred to as an access terminal, an access point, a base, a base station, a Node-B, an eNB, a gNB, a Home Node-B, a relay node, a RAN node, or by any other terminology used in the art. The base units 110 are generally part of a radio access network (“RAN”), such as the RAN 120, that may include one or more controllers communicably coupled to one or more corresponding base units 110. These and other elements of radio access network are not illustrated but are well known generally by those having ordinary skill in the art. The base units 110 connect to the mobile core network 140 via the RAN 120.

The base units 110 may serve a number of remote units 105 within a serving area, for example, a cell or a cell sector, via a wireless communication link 115. The base units 110 may communicate directly with one or more of the remote units 105 via communication signals. Generally, the base units 110 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 110. Note that during NR-U operation, the base unit 110 and the remote unit 105 communicate over unlicensed radio spectrum.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”) 141. The mobile core network 140 also includes multiple control plane functions including, but not limited to, an Access and Mobility Management Function (“AMF”) 143 that serves the RAN 120, a Session Management Function (“SMF”) 145, a Policy Control Function (“PCF”) 147, and a Unified Data Management function (“UDM”) 149.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like. In certain embodiments, the mobile core network 140 may include a AAA server.

While FIG. 1 depicts components of a 5G RAN and a 5G core network, the described embodiments apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF may be mapped to an MME, the SMF mapped to a control plane portion of a PGW and/or to an MME, the UPF map to an SGW and a user plane portion of the PGW, the UDM/UDR maps to an HSS, etc.

In the following descriptions, the term “gNB” is used for the base station but it is replaceable by any other radio access node, e.g., RAN node, cNB, BS, CNB, gNB, AP, NR, etc. Further the operations are described mainly in the context of 5G NR. However, the proposed solutions/methods are also equally applicable to other mobile communication systems supporting CSI reporting.

Regarding NR Rel. 15 Type-II Codebook, assume the gNB is equipped with a 2D antenna array with N₁, N₂ antenna ports per polarization placed horizontally and vertically and communication occurs over N₃ PMI sub-bands. A PMI subband consists of a set of resource blocks, each resource block consisting of a set of subcarriers. In such case, 2N₁N₂ CSI-RS ports are utilized to enable DL channel estimation with high resolution for NR Rel. 15 Type-II codebook. In order to reduce the UL feedback overhead, a DFT-based CSI compression of the spatial domain is applied to L dimensions per polarization, where L<N₁N₂. In the sequel the indices of the 2L dimensions are referred as the SD basis indices. The magnitude and phase values of the linear combination coefficients for each sub-band are fed back to the gNB as part of the CSI report. The 2N₁N₂×N₃ codebook per layer takes on the form:

W=W₁W₂,

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}\begin{matrix}\begin{matrix}1 & {e}^{j \frac{2 π m}{{O}_{2} {N}_{2}}}\end{matrix} & …\end{matrix} & {e}^{j \frac{2 π m ( {N}_{2} - 1 )}{{O}_{2} {N}_{2}}}\end{matrix} ] ,$$

$${v}_{l , m} = {[ \begin{matrix}\begin{matrix}\begin{matrix}{u}_{m} & {e}^{j \frac{2 π l}{{O}_{1} {N}_{1}}} {u}_{m}\end{matrix} & …\end{matrix} & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W₂ are independent for different layers.

Regarding NR Rel. 15 Type-II Port Selection Codebook, only K (where K≤2N₁N₂) beamformed CSI-RS ports are utilized in DL transmission, in order to reduce complexity. The. The K×N₃ codebook matrix per layer takes on the form:

W=W₁^{PS}W₂.

Here, W₂ follow the same structure as the conventional NR Rel. 15 Type-II Codebook and are layer specific. W₁^{PS} is a K×2L block-diagonal matrix with two identical diagonal blocks, i.e.,

$${W}_{1}^{P S} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{P S} {d}_{P S} , K / 2 )}^{( K / 2 )} & {e}_{mod ( {m}_{P S} {d}_{P S} + 1 , K / 2 )}^{( K / 2 )} & … & {e}_{mod ( {m}_{P S} {d}_{P S} + L - 1 , K / 2 )}^{( K / 2 )} ] ,\end{matrix}$$

where eᵢ^{(K)} is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

$$[ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

The NR Rel. 15 Type-I codebook is the baseline codebook for NR, with a variety of configurations. The most common utility of Rel. 15 Type-I codebook is a special case of NR Rel. 15 Type-II codebook with L=1 for RI=1,2, wherein a phase coupling value is reported for each sub-band, i.e., W₂ is 2×N₃, with the first row equal to [1, 1, . . . , 1] and the second row equal to [e^{j2πØ}^{₀}, . . . , e^{j2πØ}^{_{N3−1}}]. Under specific configurations, ϕ₀=ϕ₁ . . . =ϕ, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

Regarding the NR Rel. 16 Type-II Codebook, Assume the gNB is equipped with a two-dimensional (2D) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

W=W₁\tilde{W}₂W_{f}^{H},

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}\begin{matrix}\begin{matrix}1 & {e}^{j \frac{2 π m}{{O}_{2} {N}_{2}}}\end{matrix} & …\end{matrix} & {e}^{j \frac{2 π m ( {N}_{2} - 1 )}{{O}_{2} {N}_{2}}}\end{matrix} ] ,$$

$${v}_{l , m} = {[ \begin{matrix}\begin{matrix}\begin{matrix}{u}_{m} & {e}^{j \frac{2 π l}{{O}_{1} {N}_{1}}} {u}_{m}\end{matrix} & …\end{matrix} & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers.

W_{f} is an N₃×M matrix (M<N₃) with columns selected from a critically sampled size-N₃ DFT matrix, as follows:

$${W}_{f} = [ \begin{matrix}{f}_{{k}_{0}} & {f}_{{k}_{1}} & … & {f}_{{k}_{{M}^{′} - 1}}\end{matrix} ] , 0 \leq {k}_{i} < {N}_{3} - 1 ,$$

$${f}_{k} = {[ \begin{matrix}\begin{matrix}\begin{matrix}1 & {e}^{- j \frac{2 π k}{{N}_{3}}}\end{matrix} & …\end{matrix} & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁O₂ values. Similarly, for W_{F}, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Note that Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude, and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients'information.

Regarding NR Rel. 16, Type-II Port Selection codebook, only K (where K≤2N₁N₂) beamformed CSI-RS ports are utilized in DL transmission, in order to reduce complexity. The K×N₃ codebook matrix per layer takes on the form:

W=W₁^{PS}\tilde{W}₂W_{f}^{H}.

Here, \tilde{W}₂ and W₃ follow the same structure as the conventional NR Rel. 16 Type-II Codebook, where both are layer specific. The matrix W₁^{PS} is a K×2L block-diagonal matrix with the same structure as that in the NR Rel. 15 Type-II Port Selection Codebook.

The codebook report is partitioned into two parts based on the priority of information reported. Each part is encoded separately (Part 1 has a possibly higher code rate). Below we list the parameters for NR Rel. 16 Type-II codebook only. More details can be found in TS 38.214 Sec 5.2.3-4.

The CSI report contains:
a. Part 1: RI+CQI+Total number of coefficients
b. Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning is required to allow dynamic reporting size for codebook based on available resources in the uplink phase. More details can be found in TS 38.214 Sec 5.2.3.

Also Type-II codebook is based on aperiodic CSI reporting, and only reported in PUSCH via DCI triggering (one exception). Type-I codebook can be based on periodic CSI reporting (PUCCH) or semi-persistent CSI reporting (PUSCH or PUCCH) or aperiodic reporting (PUSCH).

Regarding Priority reporting for Part 2 CSI, note that multiple CSI reports may be transmitted, as shown in Table 1:

TABLE 1
CSI Reports priority ordering
Priority 0:
For CSI reports 1 to N_{Rep}, Group 0 CSI for CSI reports configured as
‘typeII-r16’ or ‘typeII-PortSelection-r16’; Part 2 wideband CSI for
CSI reports configured otherwise
Priority 1:
Group 1 CSI for CSI report 1, if configured as ‘typeII-r16’ or
‘typeII-PortSelection-r16’; Part 2 subband CSI of even subbands
for CSI report 1, if configured otherwise
Priority 2:
Group 2 CSI for CSI report 1, if configured as ‘typeII-r16’ or
‘typeII-PortSelection-r16’; Part 2 subband CSI of odd subbands
for CSI report 1, if configured otherwise
Priority 3:
Group 1 CSI for CSI report 2, if configured as ‘typeII-r16’ or
‘typeII-PortSelection-r16’; Part 2 subband CSI of even subbands
for CSI report 2, if configured otherwise
Priority 4:
Group 2 CSI for CSI report 2, if configured as ‘typeII-r16’ or
‘typeII-PortSelection-r16’. Part 2 subband CSI of odd subbands
for CSI report 2, if configured otherwise
.
.
.
Priority 2N_{Rep} − 1:
Group 1 CSI for CSI report N_{Rep}, if configured as ‘typeII-r16’ or
‘typeII-PortSelection-r16’; Part 2 subband CSI of even subbands
for CSI report N_{Rep}, if configured otherwise
Priority 2N_{Rep}:
Group 2 CSI for CSI report N_{Rep}, if configured as ‘typeII-r16’ or
‘typeII-PortSelection-r16’; Part 2 subband CSI of odd subbands
for CSI report N_{Rep}, if configured otherwise

Note that the priority of the N_{Rep} CSI reports is based on the following:
1. A CSI report corresponding to one CSI reporting configuration for one cell may have higher priority compared with another CSI report corresponding to one other CSI reporting configuration for the same cell.
2. CSI reports intended to one cell may have higher priority compared with other CSI reports intended to another cell.
3. CSI reports may have higher priority based on the CSI report content, e.g., CSI reports carrying L1-RSRP information have higher priority.
4. CSI reports may have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower IDs have higher priority:

Pri_{iSCI}(y, k, c, s)=2·N_{cells}·Mₛ·y+N_{cells}·Mₛ·k+Mₛ·c+s
s: CSI reporting configuration index, and Mₛ: Maximum number of CSI reporting configurations
c: Cell index, and N_{cells}: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

Regarding Triggering Aperiodic CSI Reporting on PUSCH, UE needs to report the needed CSI information for the network using the CSI framework in NR Rel. 15. The triggering mechanism between a report setting and a resource setting can be summarized in Table 2 below.

TABLE 2
Triggering mechanism between a report
setting and a resource setting

| | | Periodic CSI | SP CSI | AP CSI |
|---|---|---|---|---|
| | | reporting | reporting | Reporting |
| Time Domain | Periodic | RRC | MAC CE | DCI |
| Behavior of | CSI-RS | configured | (PUCCH) | |
| Resource | | | DCI (PUSCH) | |
| Setting | SP CSI-RS | Not | MAC CE | DCI |
| | | Supported | (PUCCH) | |
| | | | DCI (PUSCH) | |
| | AP CSI-RS | Not | Not | |
| | | Supported | Supported | DCI |

Moreover,
All associated Resource Settings for a CSI Report Setting need to have same time domain behavior.
Periodic CSI-RS/IM resource and CSI reports are assumed to be present and active once configured by RRC.
Aperiodic and semi-persistent CSI-RS/IM resources and CSI reports should be explicitly triggered or activated.
Joint triggering of Aperiodic CSI-RS/IM resources and aperiodic CSI reports via transmitting DCI Format 0-1
Semi-persistent CSI-RS/IM resources and semi-persistent CSI reports are independently activated.

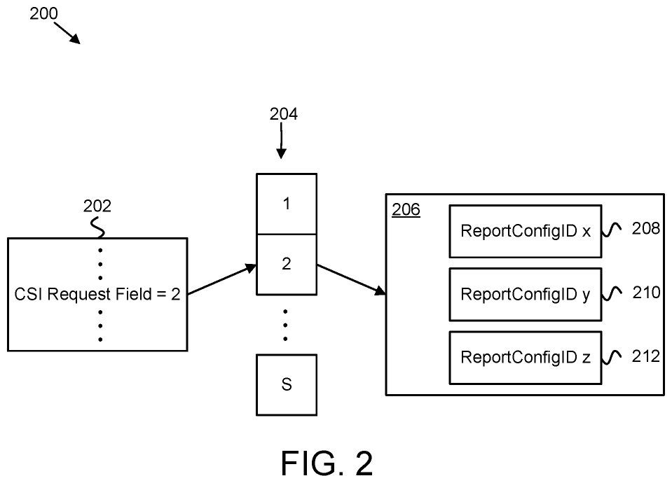

FIG. 2 depicts a diagram 200 illustrating one embodiment of an aperiodic trigger state defining a list of CSI report settings. Specifically, the diagram 200 includes a DCI format 0_1 202, a CSI request codepoint 204, and an aperiodic trigger state 2 206. Moreover, the aperiodic trigger state 2 includes a ReportConfigID x 208, a ReportConfigID y 210, and a ReportConfigID z 212. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

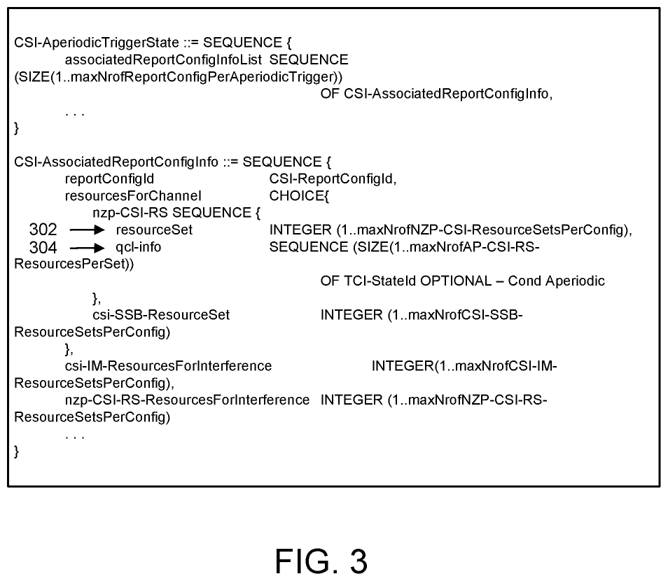

FIG. 3 depicts Aperiodic trigger state that indicates the resource set 302 and quasi co-located (“QCL”) information 304. When the CSI Report Setting is linked with aperiodic Resource Setting (can comprise multiple Resource Sets), the aperiodic non-zero power (“NZP”) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE assumes that the resources used for the computation of the channel and interference can be processed with the same spatial filter i.e., quasi-co-located with respect to “QCL-TypeD.”

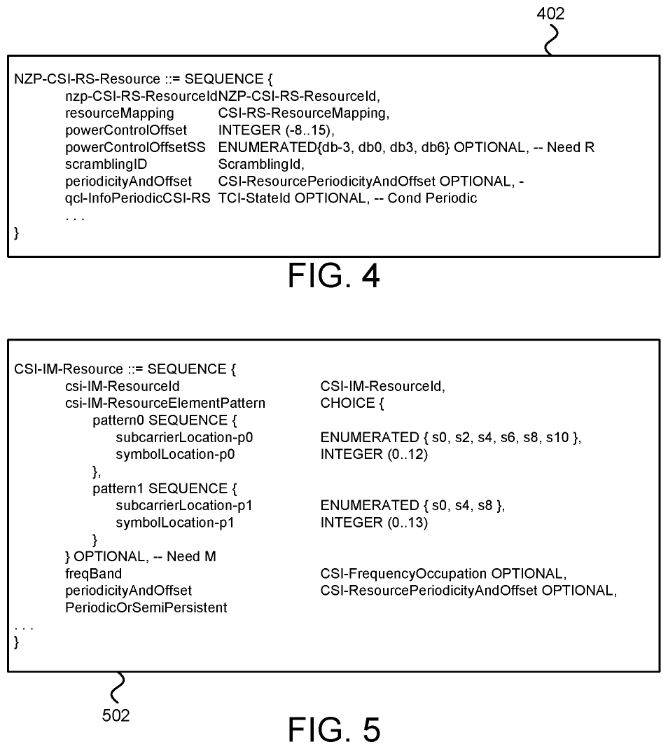

FIG. 4 is a code sample 402 illustrating one embodiment of the process by which an aperiodic trigger state indicates a resource set and QCL information.

FIG. 5 is a code sample 502 illustrating one embodiment of an RRC configuration including a non-zero power channel state information reference signal (“NZP-CSI-RS”) resource and a CSI-IM-resource. The type of uplink channels used for CSI reporting as a function of the CSI codebook type are summarized in Table 3, below:

TABLE 3
Uplink channels used for CSI reporting
as a function of the CSI codebook type

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 2 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
RI (if reported), CRI (if reported) and CQI for the first codeword,
number of non-zero wideband amplitude coefficients per layer for Type II CSI feedback on PUSCH.

CSI Part 2 has a variable payload size that can be derived from the CSI parameters in CSI Part 1 and contains PMI and the CQI for the second codeword when RI>4.

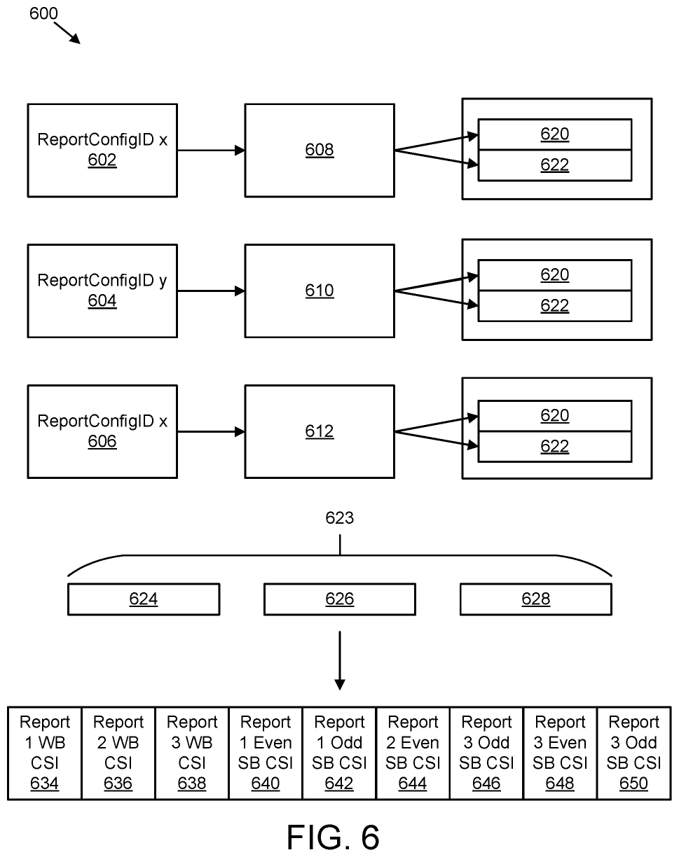

For example, if the aperiodic trigger state indicated by DCI format 0_1 defines 3 report settings x, y, and z, then the aperiodic CSI reporting for CSI part 2 will be ordered as indicated in FIG. 6.

FIG. 6 is a schematic block diagram 600 illustrating one embodiment of a partial CSI omission for PUSCH-based CSI. The diagram 600 includes a ReportConfigID x 602, a ReportConfigID y 604, and a ReportConfigID z 606. Moreover, the diagram 600 includes a first report 608 (e.g., requested quantities to be reported) corresponding to the ReportConfigID x 602, a second report 610 (e.g., requested quantities to be reported) corresponding to the ReportConfigID y 604, and a third report 612 (e.g., requested quantities to be reported) corresponding to the ReportConfigID z 606. Each of the first report 608, the second report 610, and the third report 612 includes a CSI part 1 620, and a CSI part 2 622. An ordering 623 of CSI part 2 across reports is CSI part 2 of the first report 624, CSI part 2 of the second report 626, and CSI part 2 of the third report 628. Moreover, the CSI part 2 reports may produce a report 1 WB CSI 634, a report 2 WB CSI 636, a report 3 WB CSI 638, a report 1 even SB CSI 640, a report 1 odd SB CSI 642, a report 2 even SB CSI 644, a report 2 odd SB CSI 646, a report 3 even SB CSI 648, and a report 3 odd SB CSI 650.

As mentioned earlier, CSI reports are prioritized according to:
1. Time-domain behavior and physical channel, where more dynamic reports are given precedence over less dynamic reports and PUSCH has precedence over PUCCH.
2. CSI content, where beam reports (i.e., LI-RSRP reporting) has priority over regular CSI reports.
3. the serving cell to which the CSI corresponds (in case of CA operation). CSI corresponding to the PCell has priority over CSI corresponding to Scells.
4. The CSI Reporting Setting ID reportConfigID.

Regarding UCI Bit Sequence Generation, the CSI report content in UCI, whether on PUCCH or PUSCH, is provided in detail in 3GPP TS 38.212. The Rank Indicator (RI), if reported, has bitwidth of min(┌log₂ Nₚₒᵣₜₛ┐, ┌log₂ N_{RI}┐), where Nₚₒᵣₜₛ, n_{RI} represent the number of antenna ports and the number of allowed rank indicator values, respectively. On the other hand, the CSI-RS Resource Indicator (CRI) and the Synchronization Signal Block Resource Indicator (SSBRI) each have bitwidths of ┌log₂ Kₛ^{CSI-RS}┐, ┌log₂ Kₛ^{SSB}┐, respectively, where Kₛ^{CSI-RS} is the number of CSI-RS resources in the corresponding resource set, and Kₛ^{SSB} is the configured number of SS/PBCH blocks in the corresponding resource set for reporting ‘ssb-Index-RSRP’. The mapping order of CSI fields of one CSI report with wideband PMI and wideband CQI on PUCCH is depicted in Table 4.

TABLE 4
Mapping order of CSI fields of one CSI report
with wideband PMI and CQI on PUCCH

| CSI report | |
|---|---|
| number | CSI fields |
| CSI report #n | CRI, if reported |
| | Rank Indicator, if reported |
| | Layer Indicator, if reported |
| | Zero padding bits, if needed |
| | PMI wideband information fields, if reported |
| | PMI wideband information, if reported |
| | Wideband CQI for the first Transport Block, |
| | if reported |
| | Wideband CQI for the second Transport Block, |
| | if reported |

Solutions herein are proposed that enable CSI measurement and reporting that enables more dynamic configuration and reporting, e.g., in scenarios with high-Doppler users. Different aspects of the problem have been discussed. Several other embodiments are described below. According to a possible embodiment, one or more elements or features from one or more of the described embodiments may be combined, e.g., for CSI measurement, feedback generation and/or reporting which may reduce the overall CSI feedback overhead.

Regarding an indication of enhanced CSI framework, different embodiments for indication of enhanced CSI framework to the UE are provided below, wherein CSI framework enhancements include, but are not limited to, one or more of the following aspects: CSI reporting setting, CSI resource setting, DCI signaling, CSI trigger state, CSI reporting. Considering a setup with a combination of one or more of the following embodiments is not precluded.

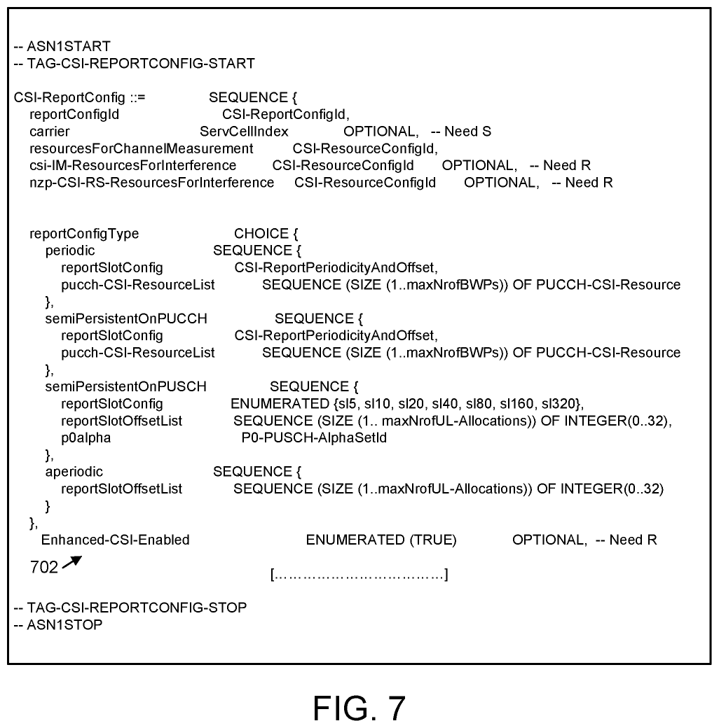

In a first embodiment, a UE configured with enhanced CSI framework may be configured with one or more CSI Reporting Settings CSI-ReportConfig, wherein at least one of the one or more CSI Reporting Settings CSI-ReportConfig includes a higher-layer parameter, e.g., enhanced-CSI-Enabled. An example of the ASN.1 code that corresponds to such CSI-ReportConfig Reporting Setting IE is provided in FIG. 7, with a higher-layer parameter 702 that triggers enhanced CSI framework. In one embodiment, the ASN.1 code for the Rel. 16 Report Setting can be found in clause 6.3.2 of 3GPP TS 38.331.

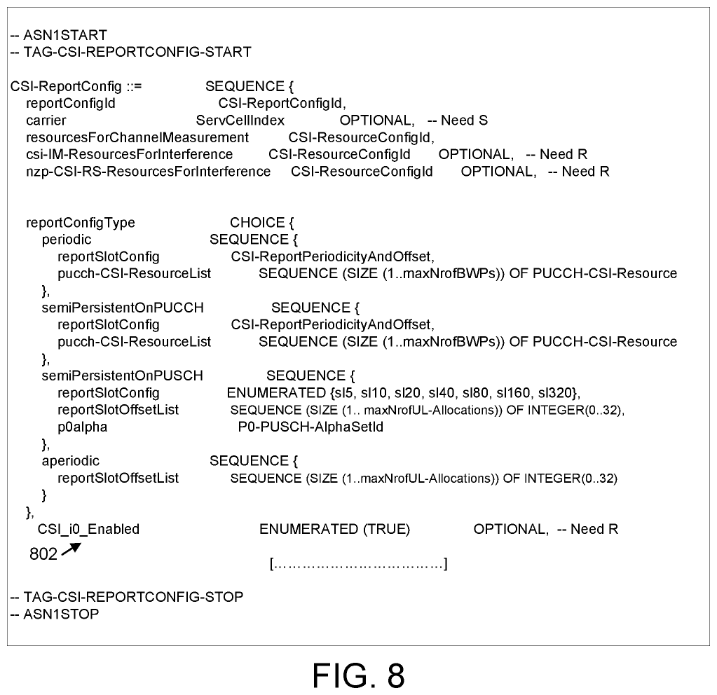

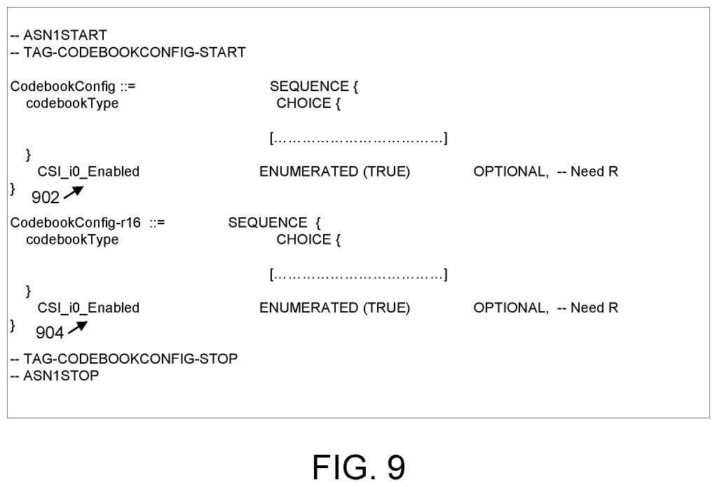

In a second embodiment, a UE configured with enhanced CSI framework may be configured with one or more CSI Reporting Settings CSI-ReportConfig, wherein at least one of the one or more CSI Reporting Settings CSI-ReportConfig includes a higher-layer parameter which triggers the UE to report an additional CSI indicator or CSI Part, e.g., CSI_i0_Enabled 802, 902, 904, in the CSI-ReportConfig Reporting Setting or any of its elements, e.g., codebookConfig. Examples of the ASN.1 code the correspond to the CSI-ReportConfig Reporting Setting IE are provided in FIG. 8 and FIG. 9, where the number of CSI Reports is triggered within the Reporting Setting or the codebook configuration, respectively.

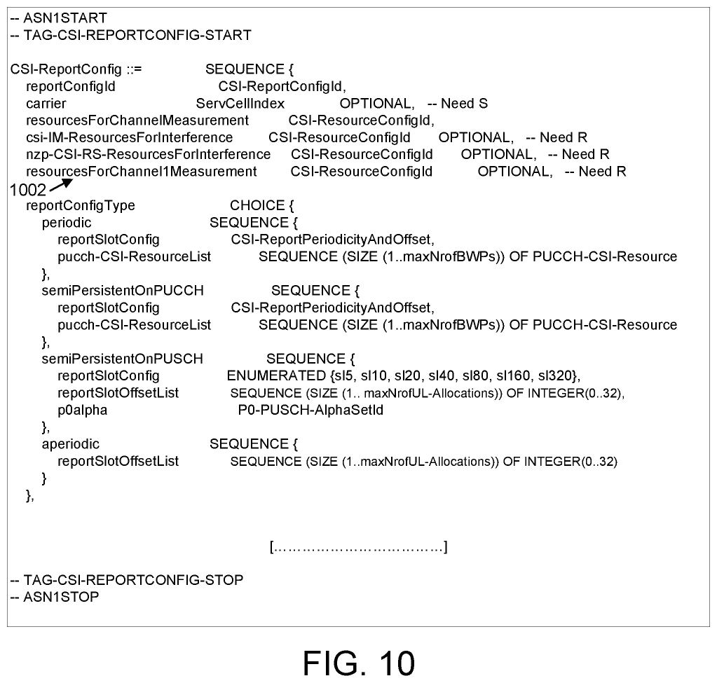

In a third embodiment, a UE configured with enhanced CSI framework may be configured with an additional higher layer parameter 1002 for CSI-RS Resources for Channel Measurement that is similar to the higher-layer parameter resourcesForChannelMeasurement in CSI-ReportConfig Report Setting, e.g., resourcesForChannel1Measurement, which can be set to similar values to the parameter resourcesForChannelMeasurement. An example of the ASN.1 code that corresponds to this setup is provided in FIG. 10 for the CSI-ReportConfig Report Setting IE.

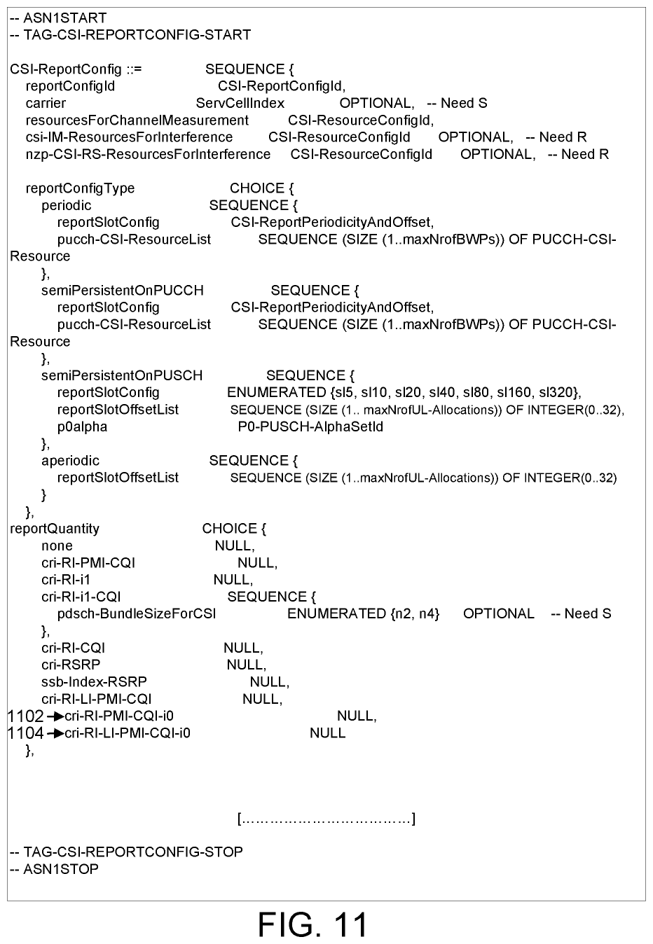

In a fourth embodiment, a UE configured with enhanced CSI framework may be configured with one or more additional values for the higher-layer parameter 1102, 1104 reportQuantity in CSI-ReportConfig Report Setting that include quantities other than those in the set {cri, ssb-Index, RSRP, SINR, RI, i1, PMI, CQI, LI}, such as i0, e.g., reportQuantity can be set to ‘cri-RI-PMI-CQI-i0’. An example of the ASN.1 code that corresponds to this setup is provided in FIG. 11.

In a fifth embodiment, a UE configured with enhanced CSI framework is expected to receive a DCI scheduling PUSCH, e.g., DCI format 0_1 and DCI format 0_2 (or another DCI format with a CSI request), wherein one codepoint of CSI Request field in DCI corresponds to two CSI trigger states.

Regarding periodic, semi-persistent CSI Resource Setting, in a first embodiment, the UE is configured with up to two CSI Resource Settings configuring two CSI-RS resource sets for channel measurement. If the UE is configured with one CSI resource setting, the CSI resource setting may include configuration of two CSI-RS resource sets for channel measurement. If the UE is configured with one CSI resource setting, the number of CSI-RS Resource Sets (S) configured is limited to one, i.e., S=1, except if the UE receives an indication of enhanced CSI framework, as discussed in Section 3.1 then the UE can be configured with two CSI-RS resource sets for channel measurement. The elements of a first of the two CSI-RS resource sets for channel measurement are a subset of elements of a second of the two CSI-RS resource sets for channel measurement.

In a first example, CSI-RS resources in the first of two CSI-RS resource sets comprise a subset of the CSI-RS resources of the second of two CSI-RS resource sets.

In a second example, CSI-RS resources of the first of two CSI-RS resource sets is the same as CSI-RS resources of the second of two CSI-RS resource sets, wherein frequency density associated with the first of two CSI-RS resource sets is an integer multiple of frequency density associated with the second of two CSI-RS resource sets.

Note here that the frequency density of CSI-RSs can be a characteristic of a CSI-RS resource set, wherein all CSI-RS resources within one CSI-RS resource set are configured with the same density, and wherein a CSI-RS resource that is included in two CSI-RS resource sets can be configured with two densities associated with the two CSI-RS resource sets, as long as a first of the two densities is an integer multiple of a second of the two densities.

In a third example, CSI-RS resources of the first of two CSI-RS resource sets (e.g., the one CSI-RS resource set corresponding to a first of the two CSI resource settings) has the same CSI-RS slot offset but periodicity an integer multiple of that of the CSI-RS resources of the second of two CSI-RS resource sets (e.g., the one CSI-RS resource set corresponding to a second of the two CSI resource settings).

Note here that the periodicity of CSI-RSs can be a characteristic of a CSI-RS resource set, wherein all CSI-RS resources within one CSI-RS resource set are configured with the same periodicity, and wherein a CSI-RS resource that is included in two CSI-RS resource sets can be configured with two periodicities (with the same offset) associated with the two CSI-RS resource sets, as long as a first of the two periodicities is an integer multiple of a second of the two periodicities.

Regarding aperiodic, semi-persistent CSI resource setting, here we discuss at least one of aperiodic CSI resource setting and semi-persistent resource setting. The UE is configured with two CSI Resource Settings, and one or two of list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig.

In a first embodiment, one codepoint of CSI Request field in at least one of DCI format 0_1 and DCI format 0_2 (or another DCI format with a CSI request) corresponds to two CSI trigger states.

In a second embodiment, two of two or more configured CSI trigger states correspond to different CSI Report configurations CSI-ReportConfig. Examples are below:
In a first example, the two CSI Report configurations comprise different report quantities report Quantity.
In a second example, the two CSI Report configurations comprise codebook configurations codebookConfig.
In a third example, the two CSI Report configurations comprise different CQI formats cqi-FormatIndicator.
In a fourth example, the two CSI Report configurations comprise different PMI formats pmi-FormatIndicator.
In a fifth example, the two CSI Report configurations comprise different reporting bands csi-ReportingBand.

In a third embodiment, the UE is configured with up to two CSI Resource Settings configuring two CSI-RS resource sets for channel measurement. If the UE is configured with one CSI resource setting, the CSI resource setting may include configuration of two CSI-RS resource sets for channel measurement. If the UE is configured with one CSI resource setting, the number of CSI-RS Resource Sets configured is limited to S=1 (e.g., for semi-persistent CSI Resource Setting), except if the UE receives indication of enhanced CSI framework, then the UE can be configured with two CSI-RS resource sets for channel measurement. Here, elements of a first of the two CSI-RS resource sets for channel measurement are a subset of elements of a second of the two CSI-RS resource sets for channel measurement.

In a first example, CSI-RS resources in the first of two CSI-RS resource sets comprise a subset of the CSI-RS resources of the second of two CSI-RS resource sets.

In a second example, CSI-RS resources of the first of two CSI-RS resource sets is the same as CSI-RS resources of the second of two CSI-RS resource sets, wherein frequency density associated with the first of two CSI-RS resource sets is an integer multiple of frequency density density associated with the second of two CSI-RS resource sets.

Note here that the frequency density density of CSI-RSs can be a characteristic of a CSI-RS resource set, wherein all CSI-RS resources within one CSI-RS resource set are configured with the same density, and wherein a CSI-RS resource that is included in two CSI-RS resource sets can be configured with two densities associated with the two CSI-RS resource sets, as long as a first of the two densities is an integer multiple of a second of the two densities.

In a third example, under semi-persistent CSI reporting on PUSCH, CSI-RS resources of the first of two CSI-RS resource sets (e.g., the one CSI-RS resource set corresponding to a first of the two CSI resource settings) has the same CSI-RS slot offset but periodicity an integer multiple of that of the CSI-RS resources of the second of two CSI-RS resource sets (e.g., the one CSI-RS resource set corresponding to a second of the two CSI resource settings).

Note here that the periodicity of CSI-RSs can be a characteristic of a CSI-RS resource set, wherein all CSI-RS resources within one CSI-RS resource set are configured with the same periodicity, and wherein a CSI-RS resource that is included in two CSI-RS resource sets can be configured with two periodicities (with the same offset) associated with the two CSI-RS resource sets, as long as a first of the two periodicities is an integer multiple of a second of the two periodicities.

Regarding CSI-RS Grouping, based on the prior arguments, the network may configure the UE with one or more CSI Reporting Settings, each configuring one or more CSI Resource Settings. If so, the CSI-RSs utilized for CSI measurement can be partitioned into at least two CSI-RS partitions.

Regarding CSI-RS Partitioning across CSI Resource and Report Settings, in a first embodiment, the at least two CSI-RS partitions are associated with different CSI Reporting Settings.

In a second embodiment, the at least two CSI-RS partitions are associated with different CSI Resource Settings corresponding to NZP CSI-RSs for channel measurement.

In a third embodiment, the at least two CSI-RS partitions are associated with different CSI-RS Resource Sets (e.g., CSI-RS Resource Sets corresponding to the same or different CSI Resource Settings) for channel measurement.

In a fourth embodiment, the at least two different CSI-RS partitions are associated with the same CSI-RS Resource Set corresponding to NZP CSI-RSs for channel measurement, wherein the different CSI-RS partitions are identified as a first CSI-RS partition and a second CSI-RS partition, respectively.

Regarding CSI-RS Partition Definition, here, a CSI-RS Partition is considered as a new unit for CSI-RSs.

In a first embodiment, a CSI-RS partition is a group of one or more CSI-RS Resource Sets. For periodic and semi-persistent CSI-RS Resource Settings, the number of CSI-RS Resource Sets configured may be limited to S=1, except when the UE is configured with two CSI-RS partitions, wherein the number of CSI-RS Resource Sets configured may be limited to S=2.

In a second embodiment, a CSI-RS partition is a group of one or more CSI-RS Resources. In a first example, a CSI-RS partition comprises a group of one or more CSI-RS Resources in the same CSI-RS Resource Set. In a second example, a CSI-RS partition comprises a group of one or more CSI-RS Resources across multiple CSI-RS Resource Sets. A UE may not be expected to be configured with more than one CSI-RS resource in resource set for channel measurement for a CSI-ReportConfig with the higher layer parameter codebookType set to either ‘typeII’, ‘typeII-PortSelection’, ‘typeII-r16’ or to ‘typeII-PortSelection-r16’, except when the UE is configured with two CSI-RS partitions, wherein the UE may be expected to be configured with two CSI-RS resources in resource set for channel measurement.

In a third embodiment, a CSI-RS partition is a group of one or more CSI-RS Ports. All CSI-RS resources within one set may be configured with same density and same nrofPorts, except when the UE is configured with two CSI-RS partitions, wherein different CSI-RS resources within one set may be configured with either different CSI-RS density or different number of ports nrofPorts, or both.

Note that according to the aforementioned embodiments, CSI-RSs associated with two CSI-RS partitions may be mutually exclusive, e.g., any CSI-RS occupying one RE of a symbol, the RE of the symbol cannot be associated with CSI-RS for more than one CSI-RS partition.

Regarding CSI Reporting, e.g., in NR Rel. 16 3GPP TS 38.214 when a higher-layer parameter CSI Report quantity reportQuantity in a CSI Report Setting ReportConfig is not set to ‘none’, a CSI report is decomposed into at least two parts: CSI Part 1, and CSI Part 2, wherein CSI Part 1 and CSI Part 2 follow the outlines described in 3GPP TS 38.214, 3GPP TS 38.212. In the following, different embodiments of CSI report decomposition are provided. According to a possible embodiment, one or more elements or features from one or more of the described embodiments may be combined.

In a first embodiment, the CSI report is further decomposed into three parts: CSI Part 0 which is comprised of one or more bits, CSI Part 1, and CSI Part 2, wherein CSI Part 1 and CSI Part 2 follow the outlines described in 3GPP TS 38.214, 3GPP TS 38.212, wherein CSI Part 0 is encoded separately from CSI Part 1 and CSI Part 2.
In a first example, CSI Part 0 is comprised of one bit that indicates a selection of one of two cases (e.g., codepoints), as follows: (i) The remainder of the CSI Report, e.g., CSI Part 1 and CSI Part 2 (if applicable) are transmitted, and (ii) The remainder of the CSI Report, e.g., CSI Part 1 and CSI Part 2 (if applicable) are not transmitted.
In a second example, CSI Part 0 is comprised of two bits that indicate one of at least three states: (i) The remainder of the CSI Report, e.g., both CSI Part 1 and CSI Part 2 (if applicable), is transmitted, and (ii) Only CSI Part 1 is transmitted, and (iii) The remainder of the CSI Report, e.g., both CSI Part 1 and CSI Part 2 (if applicable), is not transmitted.
In a third example, CSI Part 0 is comprised of one bit that indicates whether CSI feedback report is computed according to a first or a second of two CSI Reporting Settings configuring the UE, e.g., CSI Part 0 indicates the index of the CSI Reporting Setting upon which the remainder of the CSI report is based.
In a fourth example, CSI Part 0 is comprised of one bit that indicates whether CSI feedback report is computed according to a first or a second of the two CSI-RS partitions associated with one or more CSI Reporting Settings, wherein a CSI-RS Partition is defined in Section 3.3, e.g., CSI Part 0 indicates the index of the CSI-RS partition upon which the remainder of the CSI report is based.
In a fifth example, CSI Part 0 is comprised of two groups of bits with at least one bit per group, e.g., first and second groups comprise two bits and one bit, respectively, wherein the two bits corresponding to a first of the two groups of bits indicates one of three codepoints, corresponding to the cases where (i) The remainder of the CSI Report, e.g., both CSI Part 1 and CSI Part 2 (if applicable), is transmitted, and (ii) Only CSI Part 1 is transmitted, and (iii) The remainder of the CSI Report, e.g., both CSI Part 1 and CSI Part 2 (if applicable), is not transmitted. The one bit corresponding to a second of the two groups of bits indicates whether CSI feedback report is computed according to a first or a second of the two CSI-RS partitions associated with one or more CSI Reporting Settings, wherein a CSI-RS Partition is defined above.

In a second embodiment, one codepoint of CSI Part 1 corresponds to the case where CSI Part 2 is not transmitted.
In a first example, if CSI Part 1 corresponds to a maximum of 60 valid codepoints, at least 8 bits (that can indicate up to 2⁸=64 codepoints), are needed to feedback CSI Part 1, where four (64−60-4) residual codepoints of CSI Part 1 are available. According to this embodiment, at least one of the four residual codepoints can correspond to the case where CSI Part 2 is not transmitted, e.g., reporting any of the four residual codepoints can be used as an indication to the network that CSI Part 2 is not transmitted.

Regarding antenna Panel/Port, Quasi-collocation, TCI state, Spatial Relation, in some embodiments, the terms antenna, panel, and antenna panel are used interchangeably. An antenna panel may be a hardware that is used for transmitting and/or receiving radio signals at frequencies lower than 6 GHz, e.g., FR1, or higher than 6 GHz, e.g., FR2 or mmWave. In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mm Wave, FR2 and beyond), where essentially the UE may not be able to perform omni-directional transmission, i.e., the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

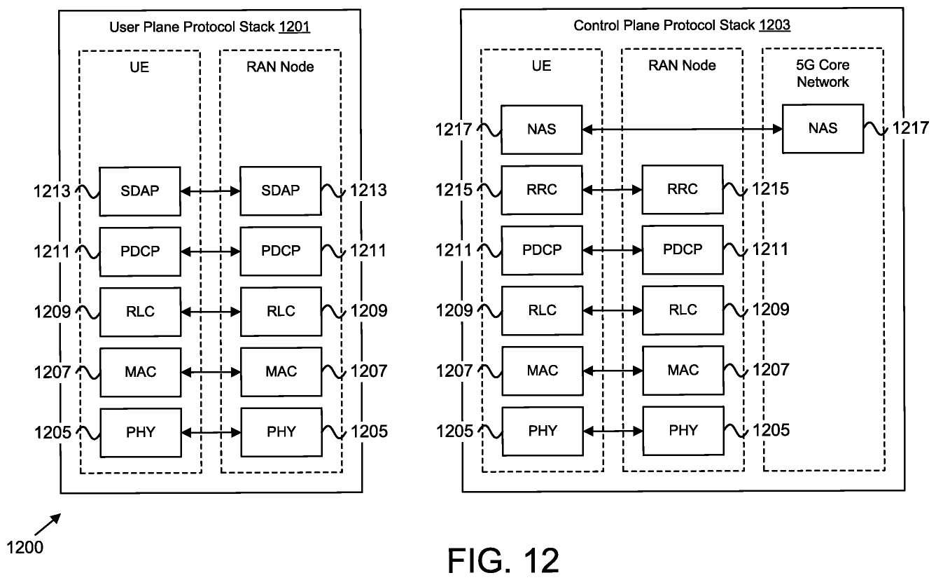

FIG. 12 depicts a protocol stack 1200, according to embodiments of the disclosure. While FIG. 12 shows a UE, a RAN node and a 5G core network, these are representative of a set of remote units 105 interacting with a base unit 121 and a mobile core network 140. As depicted, the protocol stack 1200 comprises a User Plane protocol stack 1201 and a Control Plane protocol stack 1203. The User Plane protocol stack 1201 includes a physical (“PHY”) layer 1205, a Medium Access Control (“MAC”) sublayer 1207, the Radio Link Control (“RLC”) sublayer 1209, a Packet Data Convergence Protocol (“PDCP”) sublayer 1211, and Service Data Adaptation Protocol (“SDAP”) layer 1213. The Control Plane protocol stack 1203 includes a physical layer 1205, a MAC sublayer 1207, a RLC sublayer 1209, and a PDCP sublayer 1211. The Control Place protocol stack 1203 also includes a Radio Resource Control (“RRC”) layer 1215 and a Non-Access Stratum (“NAS”) layer 1217.

The AS layer (also referred to as “AS protocol stack”) for the User Plane protocol stack 1201 consists of at least SDAP, PDCP, RLC and MAC sublayers, and the physical layer. The AS layer for the Control Plane protocol stack 1203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 1215 and the NAS layer 1217 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The physical layer 1205 offers transport channels to the MAC sublayer 1207. The MAC sublayer 1207 offers logical channels to the RLC sublayer 1209. The RLC sublayer 1209 offers RLC channels to the PDCP sublayer 1211. The PDCP sublayer 1211 offers radio bearers to the SDAP sublayer 1213 and/or RRC layer 1215. The SDAP sublayer 1213 offers QoS flows to the core network (e.g., 5GC). The RRC layer 1215 provides for the addition, modification, and release of Carrier Aggregation and/or Dual Connectivity. The RRC layer 1215 also manages the establishment, configuration, maintenance, and release of Signaling Radio Bearers (“SRBs”) and Data Radio Bearers (“DRBs”).

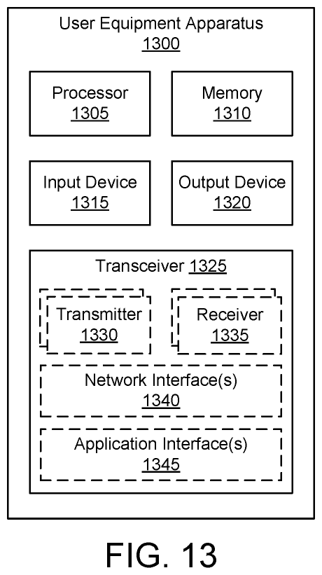

FIG. 13 depicts a user equipment apparatus 1300 that may be used for channel state information reporting configuration for dynamic user scenarios. In various embodiments, the user equipment apparatus 1300 is used to implement one or more of the solutions described above. The user equipment apparatus 1300 may be one embodiment of a UE, such as the remote unit 105 and/or the UE 1305, as described above. Furthermore, the user equipment apparatus 1300 may include a processor 1305, a memory 1310, an input device 1315, an output device 1320, and a transceiver 1325. In some embodiments, the input device 1315 and the output device 1320 are combined into a single device, such as a touchscreen. In certain embodiments, the user equipment apparatus 1300 may not include any input device 1315 and/or output device 1320. In various embodiments, the user equipment apparatus 1300 may include one or more of: the processor 1305, the memory 1310, and the transceiver 1325, and may not include the input device 1315 and/or the output device 1320.

As depicted, the transceiver 1325 includes at least one transmitter 1330 and at least one receiver 1335. Here, the transceiver 1325 communicates with one or more base units 121. Additionally, the transceiver 1325 may support at least one network interface 1340 and/or application interface 1345. The application interface(s) 1345 may support one or more APIs. The network interface(s) 1340 may support 13GPP reference points, such as Uu and PC5. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325.

In various embodiments, the processor 1305 controls the user equipment apparatus 1300 to implement the above-described UE behaviors for channel state information reporting configuration for dynamic user scenarios.

The memory 1310, in one embodiment, is a computer readable storage medium. In some embodiments, the memory 1310 includes volatile computer storage media. For example, the memory 1310 may include a RAM, including dynamic RAM (“DRAM”), synchronous dynamic RAM (“SDRAM”), and/or static RAM (“SRAM”). In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data related to channel state information reporting configuration for dynamic user scenarios. For example, the memory 1310 may store UL, DL and/or SL resource configurations, measurement configuration, UE configurations, beam management states, and the like. In certain embodiments, the memory 1310 also stores program code and related data, such as an operating system or other controller algorithms operating on the remote unit 135.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, is designed to output visual, audible, and/or haptic signals. In some embodiments, the output device 1320 includes an electronically controllable display or display device capable of outputting visual data to a user. For example, the output device 1320 may include, but is not limited to, an LCD display, an LED display, an OLED display, a projector, or similar display device capable of outputting images, text, or the like to a user. As another, non-limiting, example, the output device 1320 may include a wearable display separate from, but communicatively coupled to, the rest of the user equipment apparatus 1300, such as a smart watch, smart glasses, a heads-up display, or the like. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all, or portions of the output device 1320 may be integrated with the input device 1315. For example, the input device 1315 and output device 1320 may form a touchscreen or similar touch-sensitive display. In other embodiments, the output device 1320 may be located near the input device 1315.

The transceiver 1325 includes at least transmitter 1330 and at least one receiver 1335. The transceiver 1325 may be used to provide UL communication signals to a base unit 121 and to receive DL communication signals from the base unit 121, as described herein. Similarly, the transceiver 1325 may be used to transmit and receive SL signals (e.g., V2X communication), as described herein. Although only one transmitter 1330 and one receiver 1335 are illustrated, the user equipment apparatus 1300 may have any suitable number of transmitters 1330 and receivers 1335. Further, the transmitter(s) 1330 and the receiver(s) 1335 may be any suitable type of transmitters and receivers. In one embodiment, the transceiver 1325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1325, transmitters 1330, and receivers 1335 may be implemented as physically separate components that access a shared hardware resource and/or software resource, such as for example, the network interface 1340.

In various embodiments, one or more transmitters 1330 and/or one or more receivers 1335 may be implemented and/or integrated into a single hardware component, such as a multi-transceiver chip, a system-on-a-chip, an ASIC, or other type of hardware component. In certain embodiments, one or more transmitters 1330 and/or one or more receivers 1335 may be implemented and/or integrated into a multi-chip module. In some embodiments, other components such as the network interface 1340 or other hardware components/circuits may be integrated with any number of transmitters 1330 and/or receivers 1335 into a single chip. In such embodiment, the transmitters 1330 and receivers 1335 may be logically configured as a transceiver 1325 that uses one more common control signals or as modular transmitters 1330 and receivers 1335 implemented in the same hardware chip or in a multi-chip module.

In one embodiment, the transceiver 1325 receives, from a network, a set of one or more channel state information (“CSI”) reporting settings for configuring the UE for CSI reporting. In one embodiment, the transceiver 1325 receives, from the network, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the transceiver 1325 receives, from the network, an indication of an enhanced CSI configuration associated with at least one of the one or more received CSI reporting settings and the at least two received CSI resource settings. In one embodiment, the processor 1305 generates, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement. In one embodiment, the transceiver 1325 transmits, to the network, the one or more generated CSI reports.

In one embodiment, CSI-RS resources of a first of the two CSI-RS resource sets is a subset of CSI-RS resources of a second of the two CSI-RS resource sets.

In one embodiment, CSI-RS resources of a first of the two CSI-RS resource sets comprise an integer multiple frequency density of CSI-RS resources in a second of the two CSI-RS resource sets.

In one embodiment, CSI-RS resources of a first of the two CSI-RS resource sets comprise an integer multiple time periodicity and a same slot offset of CSI-RS resources in a second of the two CSI-RS resource sets.

In one embodiment, two CSI reporting settings within the set of one or more CSI reporting settings differ in one or more of report quantity, codebook configuration, channel quality indicator (“CQI”) format, precoding matrix indicator (“PMI”) format, and CSI reporting bands.

In one embodiment, the set of CSI-RSs are partitioned into at least two partitions corresponding to at least one of the following associations: each CSI-RS partition is associated with a CSI reporting setting, each CSI-RS partition is associated with a CSI resource setting, each CSI-RS partition is associated with a CSI-RS resource set for channel measurement, and the at least two CSI-RS partitions are associated with the same CSI-RS resource set corresponding to non-zero power CSI-RSs (“NZP-CSI-RSs”) for channel measurement.

In one embodiment, a CSI-RS partition comprises at least one of a group of one or more CSI-RS resource sets, a group of one or more CSI-RS resources within a same CSI-RS resource set, and a group of one or more CSI-RS ports within a CSI-RS resource.

In one embodiment, the processor 1305 decomposes a CSI report of the at least one CSI reports into three parts: CSI report Part 0, CSI report Part 1, and CSI report Part 2.

In one embodiment, the processor 1305 encodes CSI report Part 0 separately from CSI report Part 1 and CSI report Part 2.

In one embodiment, CSI report Part 0 indicates whether one or more of CSI report Part 1 and CSI report Part 2 are reported.

In one embodiment, CSI report Part 0 indicates at least one of an index of a CSI resource setting of the at least two CSI resource settings on which the CSI report is based, an index of a CSI-RS partition of one or more CSI-RS partitions on which the CSI report is based, and an index of a CSI reporting setting of the one or more CSI reporting settings on which the CSI report is based.

In one embodiment, the indication of the enhanced CSI configuration comprises one or more of a higher-layer parameter associated with the set of one or more CSI reporting settings that enables or disables the enhanced CSI configuration; a higher-layer parameter associated with one of the set of one or more CSI reporting settings and a codebook configuration configured within the set of one or more CSI reporting settings, the higher-layer parameter configuring the UE to report an additional CSI report part in the one or more CSI reports, the additional CSI report part comprising a sequence of one or more bits indicated by the UE; an additional CSI resource setting for channel measurement; an additional value corresponding to a higher layer parameter report quantity in a CSI reporting setting, the additional value corresponding to a CSI report Part 0; and a codepoint of a CSI request in a downlink control information (“DCI”), the codepoint corresponding to two CSI trigger states.

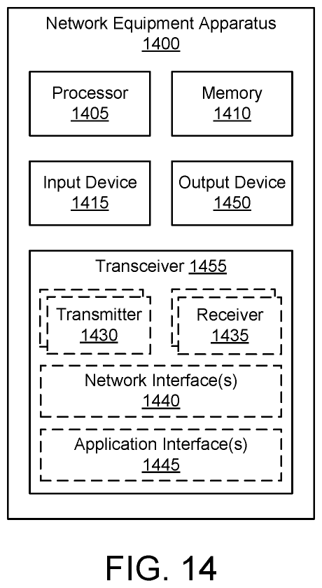

FIG. 14 depicts one embodiment of a network equipment apparatus 1400 that may be used for channel state information reporting configuration for dynamic user scenarios, according to embodiments of the disclosure. In some embodiments, the network apparatus 1400 may be one embodiment of a RAN node and its supporting hardware, such as the base unit 121 and/or gNB, described above. Furthermore, network equipment apparatus 1400 may include a processor 1405, a memory 1410, an input device 1415, an output device 1420, and a transceiver 1425. In certain embodiments, the network equipment apparatus 1400 does not include any input device 1415 and/or output device 1420.

As depicted, the transceiver 1425 includes at least one transmitter 1430 and at least one receiver 1435. Here, the transceiver 1425 communicates with one or more remote units 105. Additionally, the transceiver 1425 may support at least one network interface 1440 and/or application interface 1445. The application interface(s) 1445 may support one or more APIs. The network interface(s) 1440 may support 3GPP reference points, such as Uu, N1, N2 and N3 interfaces. Other network interfaces 1440 may be supported, as understood by one of ordinary skill in the art.

The processor 1405, in one embodiment, may include any known controller capable of executing computer-readable instructions and/or capable of performing logical operations. For example, the processor 1405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1405 executes instructions stored in the memory 1410 to perform the methods and routines described herein. The processor 1405 is communicatively coupled to the memory 1410, the input device 1415, the output device 1420, and the transceiver 1425.

In various embodiments, the processor 1405 controls the network equipment apparatus 1400 to implement the above-described network entity behaviors (e.g., of the gNB) for channel state information reporting configuration for dynamic user scenarios.

The memory 1410, in one embodiment, is a computer readable storage medium. In some embodiments, the memory 1410 includes volatile computer storage media. For example, the memory 1410 may include a RAM, including dynamic RAM (“DRAM”), synchronous dynamic RAM (“SDRAM”), and/or static RAM (“SRAM”). In some embodiments, the memory 1410 includes non-volatile computer storage media. For example, the memory 1410 may include a hard disk drive, a flash memory, or any other suitable non-volatile computer storage device. In some embodiments, the memory 1410 includes both volatile and non-volatile computer storage media.

In some embodiments, the memory 1410 stores data relating to channel state information reporting configuration for dynamic user scenarios. For example, the memory 1410 may store UL, DL and/or SL resource configurations, measurement configuration, UE configurations, beam management states, and the like. In certain embodiments, the memory 1410 also stores program code and related data, such as an operating system (“OS”) or other controller algorithms operating on the network equipment apparatus 1400 and one or more software applications.

The input device 1415, in one embodiment, may include any known computer input device including a touch panel, a button, a keyboard, a stylus, a microphone, or the like. In some embodiments, the input device 1415 may be integrated with the output device 1420, for example, as a touchscreen or similar touch-sensitive display. In some embodiments, the input device 1415 includes a touchscreen such that text may be input using a virtual keyboard displayed on the touchscreen and/or by handwriting on the touchscreen. In some embodiments, the input device 1415 includes two or more different devices, such as a keyboard and a touch panel.

The output device 1420, in one embodiment, may include any known electronically controllable display or display device. The output device 1420 may be designed to output visual, audible, and/or haptic signals. In some embodiments, the output device 1420 includes an electronic display capable of outputting visual data to a user. Further, the output device 1420 may be a component of a smart phone, a personal digital assistant, a television, a table computer, a notebook (laptop) computer, a personal computer, a vehicle dashboard, or the like.

In certain embodiments, the output device 1420 includes one or more speakers for producing sound. For example, the output device 1420 may produce an audible alert or notification (e.g., a beep or chime). In some embodiments, the output device 1420 includes one or more haptic devices for producing vibrations, motion, or other haptic feedback. In some embodiments, all, or portions of the output device 1420 may be integrated with the input device 1415. For example, the input device 1415 and output device 1420 may form a touchscreen or similar touch-sensitive display. In other embodiments, all, or portions of the output device 1420 may be located near the input device 1415.

As discussed above, the transceiver 1425 may communicate with one or more remote units and/or with one or more interworking functions that provide access to one or more PLMNs. The transceiver 1425 may also communicate with one or more network functions (e.g., in the mobile core network 140). The transceiver 1425 operates under the control of the processor 1405 to transmit messages, data, and other signals and also to receive messages, data, and other signals. For example, the processor 1405 may selectively activate the transceiver (or portions thereof) at particular times in order to send and receive messages.

The transceiver 1425 may include one or more transmitters 1430 and one or more receivers 1435. In certain embodiments, the one or more transmitters 1430 and/or the one or more receivers 1435 may share transceiver hardware and/or circuitry. For example, the one or more transmitters 1430 and/or the one or more receivers 1435 may share antenna(s), antenna tuner(s), amplifier(s), filter(s), oscillator(s), mixer(s), modulator/demodulator(s), power supply, and the like. In one embodiment, the transceiver 1425 implements multiple logical transceivers using different communication protocols or protocol stacks, while using common physical hardware.

In one embodiment, the transceiver 1425 transmits, to a user equipment (“UE”), a set of one or more channel state information (“CSI”) reporting settings for configuring the UE for CSI reporting. In one embodiment, the transceiver 1425 transmits, to the UE, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the transceiver 1425 transmits, to the UE, an indication of an enhanced CSI configuration associated with at least one of the one or more received CSI reporting settings and the at least two received CSI resource settings. In one embodiment, the transceiver 1425 receives, from the UE, one or more CSI reports generated based on at least one of a subset of the set of one or more received CSI reporting settings for configuring the UE for CSI reporting and a subset of the received set of two or more CSI resource settings for configuring the UE for CSI measurement.

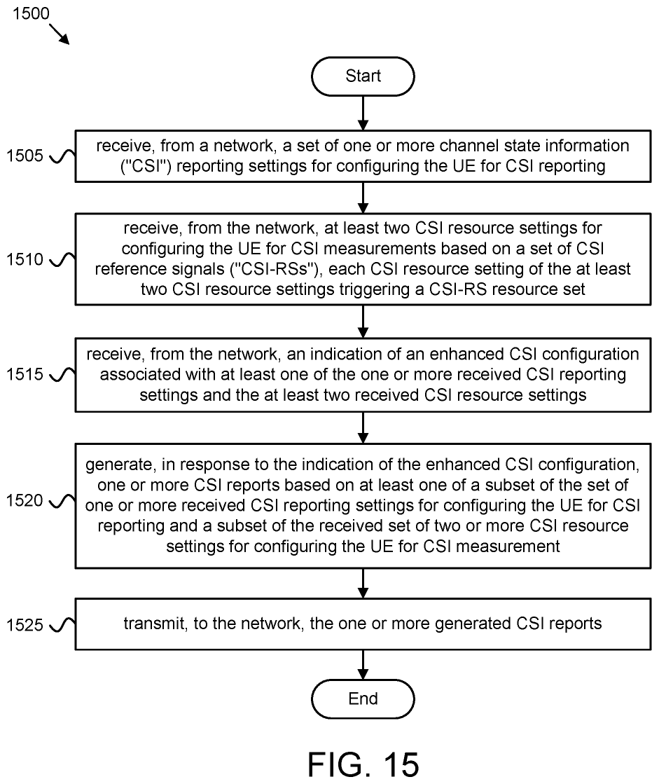

FIG. 15 is a flowchart diagram of a method 1500 for channel state information reporting configuration for dynamic user scenarios. The method 1500 may be performed by a UE as described herein, for example, the remote unit 105 and/or the user equipment apparatus 1300. In some embodiments, the method 1500 may be performed by a processor executing program code, for example, a microcontroller, a microprocessor, a CPU, a GPU, an auxiliary processing unit, a FPGA, or the like.

In one embodiment, the method 1500 begins and receives 1505, from a network, a set of one or more channel state information (“CSI”) reporting settings for configuring the UE for CSI reporting. In one embodiment, the method 1500 receives 1510, from the network, at least two CSI resource settings for configuring the UE for CSI measurements based on a set of CSI reference signals (“CSI-RSs”), each CSI resource setting of the at least two CSI resource settings triggering a CSI-RS resource set.

In one embodiment, the method 1500 receives 1515, from the network, an indication of an enhanced CSI configuration associated with at least one of the one or more received CSI reporting settings and the at least two received CSI resource settings. In one embodiment, the method 1500 generates 1520, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement. In one embodiment, the method 1500 transmits 1525, to the network, the one or more generated CSI reports, and the method 1500 ends.

Disclosed is a first apparatus for channel state information reporting configuration for dynamic user scenarios. The first apparatus may include a UE as described herein, for example, the remote unit 105 and/or the user equipment apparatus 1300. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver that receives, from a network, a set of one or more channel state information (“CSI”) reporting settings for configuring the UE for CSI reporting. In one embodiment, the transceiver receives, from the network, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the transceiver receives, from the network, an indication of an enhanced CSI configuration associated with at least one of the one or more received CSI reporting settings and the at least two received CSI resource settings. In one embodiment, the first apparatus includes a processor that generates, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement. In one embodiment, the transceiver transmits, to the network, the one or more generated CSI reports.

In one embodiment, CSI-RS resources of a first of the two CSI-RS resource sets is a subset of CSI-RS resources of a second of the two CSI-RS resource sets.

In one embodiment, CSI-RS resources of a first of the two CSI-RS resource sets comprise an integer multiple frequency density of CSI-RS resources in a second of the two CSI-RS resource sets.

In one embodiment, CSI-RS resources of a first of the two CSI-RS resource sets comprise an integer multiple time periodicity and a same slot offset of CSI-RS resources in a second of the two CSI-RS resource sets.

In one embodiment, two CSI reporting settings within the set of one or more CSI reporting settings differ in one or more of report quantity, codebook configuration, channel quality indicator (“CQI”) format, precoding matrix indicator (“PMI”) format, and CSI reporting bands.

In one embodiment, the set of CSI-RSs are partitioned into at least two partitions corresponding to at least one of the following associations: each CSI-RS partition is associated with a CSI reporting setting, each CSI-RS partition is associated with a CSI resource setting, each CSI-RS partition is associated with a CSI-RS resource set for channel measurement, and the at least two CSI-RS partitions are associated with the same CSI-RS resource set corresponding to non-zero power CSI-RSs (“NZP-CSI-RSs”) for channel measurement.

In one embodiment, a CSI-RS partition comprises at least one of a group of one or more CSI-RS resource sets, a group of one or more CSI-RS resources within a same CSI-RS resource set, and a group of one or more CSI-RS ports within a CSI-RS resource.

In one embodiment, the processor decomposes a CSI report of the at least one CSI reports into three parts: CSI report Part 0, CSI report Part 1, and CSI report Part 2.

In one embodiment, the processor encodes CSI report Part 0 separately from CSI report Part 1 and CSI report Part 2.

In one embodiment, CSI report Part 0 indicates whether one or more of CSI report Part 1 and CSI report Part 2 are reported.

In one embodiment, CSI report Part 0 indicates at least one of an index of a CSI resource setting of the at least two CSI resource settings on which the CSI report is based, an index of a CSI-RS partition of one or more CSI-RS partitions on which the CSI report is based, and an index of a CSI reporting setting of the one or more CSI reporting settings on which the CSI report is based.

In one embodiment, the indication of the enhanced CSI configuration comprises one or more of a higher-layer parameter associated with the set of one or more CSI reporting settings that enables or disables the enhanced CSI configuration; a higher-layer parameter associated with one of the set of one or more CSI reporting settings and a codebook configuration configured within the set of one or more CSI reporting settings, the higher-layer parameter configuring the UE to report an additional CSI report part in the one or more CSI reports, the additional CSI report part comprising a sequence of one or more bits indicated by the UE; an additional CSI resource setting for channel measurement; an additional value corresponding to a higher layer parameter report quantity in a CSI reporting setting, the additional value corresponding to a CSI report Part 0; and a codepoint of a CSI request in a downlink control information (“DCI”), the codepoint corresponding to two CSI trigger states.

Disclosed is a first method for channel state information reporting configuration for dynamic user scenarios. The first method may by performed by a UE as described herein, for example, the remote unit 105 and/or the user equipment apparatus 1300. In some embodiments, the first method may be performed by a processor executing program code, for example, a microcontroller, a microprocessor, a CPU, a GPU, an auxiliary processing unit, a FPGA, or the like.

In one embodiment, the first method receives, from a network, a set of one or more channel state information (“CSI”) reporting settings for configuring the UE for CSI reporting. In one embodiment, the first method receives, from the network, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the first method receives, from the network, an indication of an enhanced CSI configuration associated with at least one of the one or more received CSI reporting settings and the at least two received CSI resource settings. In one embodiment, the first method generates, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement. In one embodiment, the first method transmits, to the network, the one or more generated CSI reports.

In one embodiment, CSI-RS resources of a first of the two CSI-RS resource sets is a subset of CSI-RS resources of a second of the two CSI-RS resource sets.

In one embodiment, CSI-RS resources of a first of the two CSI-RS resource sets comprise an integer multiple frequency density of CSI-RS resources in a second of the two CSI-RS resource sets.

In one embodiment, CSI-RS resources of a first of the two CSI-RS resource sets comprise an integer multiple time periodicity and a same slot offset of CSI-RS resources in a second of the two CSI-RS resource sets.

In one embodiment, two CSI reporting settings within the set of one or more CSI reporting settings differ in one or more of report quantity, codebook configuration, channel quality indicator (“CQI”) format, precoding matrix indicator (“PMI”) format, and CSI reporting bands.

In one embodiment, the set of CSI-RSs are partitioned into at least two partitions corresponding to at least one of the following associations: each CSI-RS partition is associated with a CSI reporting setting, each CSI-RS partition is associated with a CSI resource setting, each CSI-RS partition is associated with a CSI-RS resource set for channel measurement, and the at least two CSI-RS partitions are associated with the same CSI-RS resource set corresponding to non-zero power CSI-RSs (“NZP-CSI-RSs”) for channel measurement.

In one embodiment, a CSI-RS partition comprises at least one of a group of one or more CSI-RS resource sets, a group of one or more CSI-RS resources within a same CSI-RS resource set, and a group of one or more CSI-RS ports within a CSI-RS resource.

In one embodiment, the first method decomposes a CSI report of the at least one CSI reports into three parts: CSI report Part 0, CSI report Part 1, and CSI report Part 2.

In one embodiment, the first method encodes CSI report Part 0 separately from CSI report Part 1 and CSI report Part 2.

In one embodiment, CSI report Part 0 indicates whether one or more of CSI report Part 1 and CSI report Part 2 are reported.

In one embodiment, CSI report Part 0 indicates at least one of an index of a CSI resource setting of the at least two CSI resource settings on which the CSI report is based, an index of a CSI-RS partition of one or more CSI-RS partitions on which the CSI report is based, and an index of a CSI reporting setting of the one or more CSI reporting settings on which the CSI report is based.

In one embodiment, the indication of the enhanced CSI configuration comprises one or more of a higher-layer parameter associated with the set of one or more CSI reporting settings that enables or disables the enhanced CSI configuration; a higher-layer parameter associated with one of the set of one or more CSI reporting settings and a codebook configuration configured within the set of one or more CSI reporting settings, the higher-layer parameter configuring the UE to report an additional CSI report part in the one or more CSI reports, the additional CSI report part comprising a sequence of one or more bits indicated by the UE; an additional CSI resource setting for channel measurement; an additional value corresponding to a higher layer parameter report quantity in a CSI reporting setting, the additional value corresponding to a CSI report Part 0; and a codepoint of a CSI request in a downlink control information (“DCI”), the codepoint corresponding to two CSI trigger states.

Disclosed is a second apparatus for channel state information reporting configuration for dynamic user scenarios. The second apparatus may include a network device as described herein, for example, the base unit 121 and/or the network equipment apparatus 1400. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver that transmits, to a user equipment (“UE”), a set of one or more channel state information (“CSI”) reporting settings for configuring the UE for CSI reporting. In one embodiment, the transceiver transmits, to the UE, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the transceiver transmits, to the UE, an indication of an enhanced CSI configuration associated with at least one of the one or more received CSI reporting settings and the at least two received CSI resource settings. In one embodiment, the transceiver receives, from the UE, one or more CSI reports generated based on at least one of a subset of the set of one or more received CSI reporting settings for configuring the UE for CSI reporting and a subset of the received set of two or more CSI resource settings for configuring the UE for CSI measurement.

Disclosed is a second method for channel state information reporting configuration for dynamic user scenarios. The second method may be performed by a network device as described herein, for example, the base unit 121 and/or the network equipment apparatus 1400. In some embodiments, the second method may be performed by a processor executing program code, for example, a microcontroller, a microprocessor, a CPU, a GPU, an auxiliary processing unit, a FPGA, or the like.

In one embodiment, the second method transmits, to a user equipment (“UE”), a set of one or more channel state information (“CSI”) reporting settings for configuring the UE for CSI reporting. In one embodiment, the second method transmits, to the UE, at least two CSI resource settings for configuring the UE for CSI measurements based on a set of CSI reference signals (“CSI-RSs”), each CSI resource setting of the at least two CSI resource settings triggering a CSI-RS resource set. In one embodiment, the second method transmits, to the UE, an indication of an enhanced CSI configuration associated with at least one of the one or more received CSI reporting settings and the at least two received CSI resource settings. In one embodiment, the second method receives, from the UE, one or more CSI reports generated based on at least one of a subset of the set of one or more received CSI reporting settings for configuring the UE for CSI reporting and a subset of the received set of two or more CSI resource settings for configuring the UE for CSI measurement.

Disclosed is a second method for channel state information reporting configuration for dynamic user scenarios. The second method may be performed by a network device as described herein, for example, the base unit 121 and/or the network equipment apparatus 1400. In some embodiments, the second method may be performed by a processor executing program code, for example, a microcontroller, a microprocessor, a CPU, a GPU, an auxiliary processing unit, a FPGA, or the like.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) apparatus, the apparatus comprising:
a transceiver that:
receives, from a network, a set of one or more channel state information (“CSI”) reporting settings for configuring the UE for CSI reporting;
receives, from the network, at least two CSI resource settings for configuring the UE for CSI measurements based on a set of CSI reference signals (“CSI-RSs”), each CSI resource setting of the at least two CSI resource settings triggering a CSI-RS resource set; and
receives, from the network, an indication of an enhanced CSI configuration associated with at least one of the one or more received CSI reporting settings and the at least two received CSI resource settings; and
a processor that generates, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement,
wherein the transceiver transmits, to the network, the one or more generated CSI reports.

2. The apparatus of claim 1, wherein CSI-RS resources of a first of the two CSI-RS resource sets is a subset of CSI-RS resources of a second of the two CSI-RS resource sets.

3. The apparatus of claim 1, wherein CSI-RS resources of a first of the two CSI-RS resource sets comprise an integer multiple frequency density of CSI-RS resources in a second of the two CSI-RS resource sets.

4. The apparatus of claim 1, wherein CSI-RS resources of a first of the two CSI-RS resource sets comprise an integer multiple time periodicity and a same slot offset of CSI-RS resources in a second of the two CSI-RS resource sets.

5. The apparatus of claim 1, wherein two CSI reporting settings within the set of one or more CSI reporting settings differ in one or more of report quantity, codebook configuration, channel quality indicator (“CQI”) format, precoding matrix indicator (“PMI”) format, and CSI reporting bands.

6. The apparatus of claim 1, wherein the set of CSI-RSs are partitioned into at least two partitions corresponding to at least one of the following associations:
each CSI-RS partition is associated with a CSI reporting setting;
each CSI-RS partition is associated with a CSI resource setting;
each CSI-RS partition is associated with a CSI-RS resource set for channel measurement; and
the at least two CSI-RS partitions are associated with the same CSI-RS resource set corresponding to non-zero power CSI-RSs (“NZP-CSI-RSs”) for channel measurement.

7. The apparatus of claim 6, wherein a CSI-RS partition comprises at least one of:
a group of one or more CSI-RS resource sets;
a group of one or more CSI-RS resources within a same CSI-RS resource set; and
a group of one or more CSI-RS ports within a CSI-RS resource.

8. The apparatus of claim 1, wherein the processor decomposes a CSI report of the at least one CSI reports into three parts: CSI report Part 0, CSI report Part 1, and CSI report Part 2.

9. The apparatus of claim 8, wherein the processor encodes CSI report Part 0 separately from CSI report Part 1 and CSI report Part 2.

10. The apparatus of claim 8, wherein CSI report Part 0 indicates whether one or more of CSI report Part 1 and CSI report Part 2 are reported.

11. The apparatus of claim 8, wherein CSI report Part 0 indicates at least one of:
an index of a CSI resource setting of the at least two CSI resource settings on which the CSI report is based;
an index of a CSI-RS partition of one or more CSI-RS partitions on which the CSI report is based; and
an index of a CSI reporting setting of the one or more CSI reporting settings on which the CSI report is based.

12. The apparatus of claim 1, wherein the indication of the enhanced CSI configuration comprises one or more of:
a higher-layer parameter associated with the set of one or more CSI reporting settings that enables or disables the enhanced CSI configuration;
a higher-layer parameter associated with one of the set of one or more CSI reporting settings and a codebook configuration configured within the set of one or more CSI reporting settings, the higher-layer parameter configuring the UE to report an additional CSI report part in the one or more CSI reports, the additional CSI report part comprising a sequence of one or more bits indicated by the UE;
an additional CSI resource setting for channel measurement;
an additional value corresponding to a higher layer parameter report quantity in a CSI reporting setting, the additional value corresponding to a CSI report Part 0; and
a codepoint of a CSI request in a downlink control information (“DCI”), the codepoint corresponding to two CSI trigger states.

13. A method of a user equipment (“UE”), the method comprising:
receiving, from a network, a set of one or more channel state information (“CSI”) reporting settings for configuring the UE for CSI reporting;
receiving, from the network, at least two CSI resource settings for configuring the UE for CSI measurements based on a set of CSI reference signals (“CSI-RSs”), each CSI resource setting of the at least two CSI resource settings triggering a CSI-RS resource set;
receiving, from the network, an indication of an enhanced CSI configuration associated with at least one of the one or more received CSI reporting settings and the at least two received CSI resource settings;
generating, in response to the indication of the enhanced CSI configuration, one or more CSI reports based on at least one of a subset of the set of one or more received CSI reporting settings for configuring the UE for CSI reporting and a subset of the received set of two or more CSI resource settings for configuring the UE for CSI measurement; and
transmitting, to the network, the one or more generated CSI reports.

14. The method of claim 13, wherein CSI-RS resources of a first of the two CSI-RS resource sets is a subset of CSI-RS resources of a second of the two CSI-RS resource sets.

15. A network equipment apparatus, the apparatus comprising:
a transceiver that:
transmits, to a user equipment (“UE”), a set of one or more channel state information (“CSI”) reporting settings for configuring the UE for CSI reporting;
transmits, to the UE, at least two CSI resource settings for configuring the UE for CSI measurements based on a set of CSI reference signals (“CSI-RSs”), each CSI resource setting of the at least two CSI resource settings triggering a CSI-RS resource set;
transmits, to the UE, an indication of an enhanced CSI configuration associated with at least one of the one or more received CSI reporting settings and the at least two received CSI resource settings; and
receives, from the UE, one or more CSI reports generated based on at least one of a subset of the set of one or more received CSI reporting settings for configuring the UE for CSI reporting and a subset of the received set of two or more CSI resource settings for configuring the UE for CSI measurement.
